(19) United States
(12) Patent Application Publication
(10) Pub. No.: US 2024/0288673 A1
(43) Pub. Date: Aug. 29, 2024

(54) PROJECTION LENS

(71) Applicant: Goertek Optical Technology Co., Ltd., Weifang, Shandong (CN)

(72) Inventors: Pengbo Chen, Weifang, Shandong (CN); Weitao Ding, Weifang, Shandong (CN); Yixin Wang, Weifang, Shandong (CN)

(73) Assignee: Goertek Optical Technology Co., Ltd., Weifang, Shandong (CN)

(21) Appl. No.: 18/573,173

(22) PCT Filed: Dec. 14, 2021
(86) PCT No.: PCT/CN2021/137668

§ 371 Date: Dec. 21, 2023

(30) Foreign Application Priority Data
Jun. 22, 2021 (CN) 202121395120.8

(51) Int. Cl. G02B 13/18; G02B 13/16

(52) U.S. Cl. CPC G02B 13/18; G02B 13/16

(57) ABSTRACT

A projection lens, comprising: a first lens, a first glued lens, a second glued lens and a sixth lens, the first lens has a negative focal power; the first glued lens comprises a second lens and a third lens, the second lens is located between the first lens and the third lens, the second lens and the third lens are glued to each other on opposing surfaces thereof, and the first glued lens has a positive focal power; the second glued lens comprises a fourth lens and a fifth lens, the fourth lens is located between the third lens and the fifth lens, the fourth lens and the fifth lens are glued to each other on opposing surfaces thereof, and the second glued lens has a negative focal power; the sixth lens has a positive focal power.

### CROSS-REFERENCE TO RELATED APPLICATIONS

The present disclosure is a National Stage of International Application No. PCT/CN2021/137668, filed on Dec. 14, 2021, which claims priority to claims priority to Chinese patent application No. 202121395120.8, filed on Jun. 22, 2021 and entitled “PROJECTION LENS”, the entirety of which is incorporated herein by reference.

### TECHNICAL FIELD

The present disclosure relates to the field of projection imaging technologies, and in particular to a projection lens and a projection device.

### BACKGROUND

Micro-projection is a projection technology which promotes miniaturization and portability of conventional projection display devices. In the field of micro-projection technologies, micro-projection devices are gradually developing in the direction of miniaturization, high brightness and portability. Among them, a digital light procession projection device (DLP) has gradually become one of the mainstream projection devices by virtue of its high-definition picture, high-brightness image, rich color and high-contrast display.

Existing micro-projection lenses, however, are bulky and too complicated in optical structure, which is difficult to meet demands on miniaturization of the micro-projection lens, and causes difficulties in processing and assembly as well as high production costs.

### SUMMARY

The main objective of the present disclosure is to propose a projection lens, which aims to meet the demands on small-size modularization of the projection lens, eliminate the aberration of optical imaging, mitigate the difficulty of processing and assembly, and reduce the production cost.

To achieve the above objective, the present disclosure proposes a projection lens, arranged along the same optical axis from an object side to an image side, and comprises: a first lens, a first glued lens, a second glued lens and a sixth lens, the first lens has a negative focal power; the first glued lens comprises a second lens and a third lens, the second lens is located between the first lens and the third lens, the second lens and the third lens are glued to each other on opposing surfaces thereof, and the first glued lens has a positive focal power; the second glued lens comprises a fourth lens and a fifth lens, the fourth lens is located between the third lens and the fifth lens, the fourth lens and the fifth lens are glued to each other on opposing surfaces thereof, and the second glued lens has a negative focal power; the sixth lens has a positive focal power.

Optionally, the first lens has a convex surface on a side facing the object side, and a concave surface on a side facing the image side; the second lens has a concave surface on a side facing the object side, and a concave surface on a side facing the image side; the third lens has a convex surface on a side facing the object side, and a convex surface on a side facing the image side; the fourth lens has a concave surface on a side facing the object side, and a concave surface on a side facing the image side; the fifth lens has a convex surface on a side facing the object side, and a convex surface on a side facing the image side; the sixth lens has a convex surface on a side facing the object side, and a convex surface on a side facing the image side.

Optionally, the first lens has a focal length of f₁, the first glued lens has a focal length of f_{2/3}, the second glued lens has a focal length of f_{4/5}, and the sixth lens has a focal length of f₆, wherein, −15.5<f₁<−9.5, 15.5<f_{2/3}<22.5, −80.5<f_{4/5}<−52.5, 9.2<f₆<16.5.

Optionally, the projection lens has a focal length of f, wherein 5.2<f<8.5.

Optionally, the first lens is an aspheric lens; and/or, the sixth lens is an aspheric lens.

Optionally, the first lens is made of optical plastic material; and/or, the second lens, the third lens, the fourth lens, the fifth lens, and the sixth lens are all made of optical glass.

Optionally, the projection lens further comprises: a stop provided between the first glued lens and the second glued lens.

To achieve the above objective, the present disclosure further provides a projection device comprising the above-mentioned projection lens and a display unit, and the display unit is provided on a side of the sixth lens facing away from the second glued lens.

Optionally, the projection device further comprises: a right-angle prism provided between the sixth lens and the display unit.

Optionally, the projection device further comprises: a transparent protective layer provided on a side of the display unit facing away from the sixth lens.

In the technical solution of the present disclosure, the projection lens comprises: a first lens, a first glued lens, a second glued lens and a sixth lens arranged along the same optical axis from an object side to an image side, the first lens has a negative focal power; the first glued lens comprises a second lens and a third lens, and has a positive focal power; the second glued lens comprises a fourth lens and a fifth lens, and has a negative focal power; the sixth lens has a positive focal power. In the present disclosure, the projection lens is formed by the combination of only six lenses, and thus has a small number of lenses and a compact structure, so that it can meet the demands on small-size modularization of the projection lens. In addition, through the cooperative use of lenses with different structures, it is possible to effectively eliminate aberration generated in optical imaging so as to ensure the imaging quality, so that the projection lens has small distortion, small chromatic aberration and excellent optical performance, thereby achieving small size and high imaging quality. In addition, by reasonably assigning the focal power of the entire optical path of the projection lens and using two glued lenses, the projection lens has a tolerance with low sensitivity, which mitigates the difficulty of processing and assembling the lens, and thus reduces production costs.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 shows a schematic structural illustration of a projection lens in an embodiment of the present disclosure;

FIG. 2 shows a schematic illustration of an optical path of a projection lens in an embodiment of the present disclosure;

FIG. 3 shows graphs of modulation transfer function of a projection lens in an embodiment of the present disclosure;

FIG. 4 shows a light spot illustration of a projection lens in an embodiment of the present disclosure;

FIG. 5 shows a field curvature and a distortion image of a projection lens in an embodiment of the present disclosure;

FIG. 6 shows a vertical chromatic aberration diagram of a projection lens in an embodiment of the present disclosure.

Description of reference signs:

| No. | Name |
|---|---|
| 10 | first lens |
| 20 | second lens |
| 30 | third lens |
| 40 | fourth lens |
| 50 | fifth lens |
| 60 | sixth lens |
| 70 | stop |
| 81 | display unit |
| 82 | prism |
| 83 | transparent protective layer |

The realization of the objects, functional features and advantages of the present disclosure will be further described in connection with the embodiments, with reference to the accompanying drawings

### DETAILED DESCRIPTION

Technical solutions in the embodiments of the present disclosure are described below with reference to the accompanying drawings in the embodiments of the present disclosure. Apparently, the described embodiments are merely some rather than all of the embodiments of the present disclosure. All other embodiments, acquired by those of ordinary skill in the art based on the embodiments of the present disclosure without any creative work, should fall into the protection scope of the present disclosure.

It should be noted that all directional indications (such as up, down, left, right, front, back . . . ) in the embodiment of the present disclosure are used only to explain the relative positional relationship, movement, etc., between the parts in a particular attitude (as shown in the accompanying drawings), and the directional indications are changed accordingly if that particular attitude is changed.

In addition, terms “first” and “second” involved in the present disclosure are only used for descriptive purposes and should not be understood as indicating or implying relative importance or implying a number of indicated technical features. Therefore, a feature delimited with “first”, “second” may expressly or implicitly include at least one of those features. In addition, the technical solutions between the various embodiments of the present disclosure may be combined with each other, but it must be based on the fact that it can be realized by a person of ordinary skill in the art. When the combination of technical solutions appears to be contradictory or unattainable, it should be considered that such combination of technical solutions does not exist and is not within the scope of protection claimed in the present disclosure.

The present disclosure proposes a projection lens.

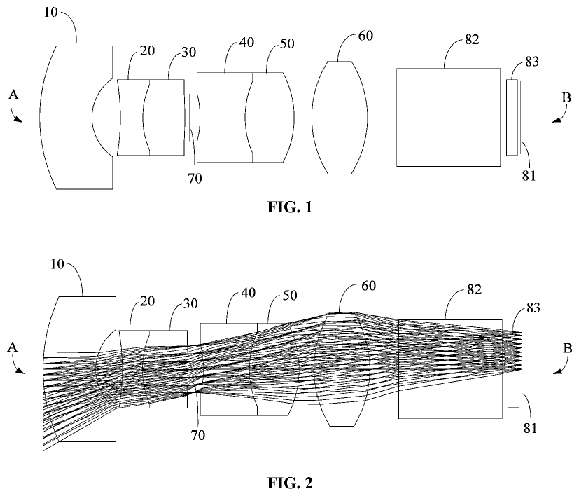

In the present embodiment, as shown in FIGS. 1-2, the projection lens is arranged along the same optical axis from an object side to an image side, and comprises: a first lens 10, a first glued lens, a second glued lens and a sixth lens 60, the first lens 10 has a negative focal power; the first glued lens comprises a second lens 20 and a third lens 30, the second lens 20 is located between the first lens 10 and the third lens 30, the second lens 20 and the third lens 30 are glued to each other on opposing surfaces thereof, and the first glued lens has a positive focal power; the second glued lens comprises a fourth lens 40 and a fifth lens 50, the fourth lens 40 is located between the third lens 30 and the fifth lens 50, the fourth lens 40 and the fifth lens 50 are glued to each other on opposing surfaces thereof, and the second glued lens has a negative focal power; the sixth lens 60 has a positive focal power.

It should be noted that the image side is the side (as shown in B in the figure) where the image source (display unit 81) of a projected image is located in the projection process, and the object side is the side (as shown in A in the figure) where the projection plane (e.g., the wall) on which the projected image is imaged is located.

Specifically, when the projection lens of the present disclosure is applied to a projection device, a display unit 81 is further provided on a side of the sixth lens 60 facing away from the second glued lens. The projection light signal is emitted by the display unit 81, is emitted from the image side toward the object side, passes through the sixth lens 60, the fifth lens 50 and the fourth lens 40 in turn (the two are glued to form the second glued lens), the third lens 30 and the second lens 20 (the two are glued to form the first glued lens) and the first lens 10, and finally is output to the projection plane on the side of the first lens 10 facing away from the first glued lens, thereby displaying the projected image.

In an optical system, a result obtained by non-paraxial light tracing is inconsistent with that obtained by paraxial light tracing, and the deviation from the ideal condition of Gaussian optics (first-order approximation theory or paraxial light) is called aberration. The aberration is mainly categorized into distortion, field curvature, chromatic aberration, spherical aberration, coma, astigmatism, etc. The aberration degrades the imaging quality of the projection lens, and therefore, when designing the projection lens, it is necessary to eliminate the aberration generated at the time of imaging by the optical system as much as possible.

Here, an focal power is the difference between a beam convergence in image side and a beam convergence in object side, which characterizes the ability of the optical system to deflect light. A lens with a negative focal power is a lens with a thin center and a thick periphery, also known as a concave lens, and has the function of dispersing light; a lens with a positive focal power is a lens with a thick center and a thin periphery, also known as a convex lens, and has the function of converging light. In the present embodiment, through the combination of the first lens 10 with the negative focal power, the first glued lens with the positive focal power, the second glued lens with the negative focal power, and the sixth lens 60 with the positive focal power, it is possible to effectively reduce the field curvature and distortion generated in the optical imaging process. On the other hand, with the first glued lens consisting of the second lens 20 and the third lens 30 and the second glued lens consisting of the fourth lens 40 and the fifth lens 50, it is possible to effectively eliminate the chromatic aberration generated in the optical imaging process. Taking the first glued lens as an example, the second lens 20 may specifically be a flint glass negative lens with a high refractive index, and the third lens 30 may specifically be a crown glass positive lens with a low refractive index. Meanwhile, by reasonably assigning the focal power of the entire optical path of the projection lens and using two glued lenses, the projection lens has a tolerance with low sensitivity (referring to the tolerance of the eccentricity of the lens from the optical axis, that is, the tolerance of the gap between the lens and the lens barrel), which mitigates the difficulty of processing and assembling the lens, and thus reduces production costs.

Therefore, in the technical solution of the present disclosure, the projection lens is formed by the combination of only six lenses, and thus has a small number of lenses and a compact structure, so that it can meet the demands on small-size modularization of the projection lens. In addition, through the cooperative use of lenses with different structures, it is possible to effectively eliminate aberration generated in optical imaging so as to ensure the imaging quality, so that the projection lens has small distortion, small chromatic aberration and excellent optical performance, thereby achieving the effects of small size and high imaging quality. In addition, by reasonably assigning the focal power of the entire optical path of the projection lens and using two glued lenses, the projection lens has a tolerance with low sensitivity, which mitigates the difficulty of processing and assembling the lens, and thus reduces production costs.

In one embodiment of the present disclosure, please refer to FIGS. 1-2, the first lens 10 has a convex surface on a side facing the object side, and a concave surface on a side facing the image side; the second lens 20 has a concave surface on a side facing the object side, and a concave surface on a side facing the image side; the third lens 30 has a convex surface on a side facing the object side, and a convex surface on a side facing the image side; the fourth lens 40 has a concave surface on a side facing the object side, and a concave surface on a side facing the image side; the fifth lens 50 has a convex surface on a side facing the object side, and a convex surface on a side facing the image side; the sixth lens 60 has a convex surface on a side facing the object side, and a convex surface on a side facing the image side.

In the present embodiment, the first lens 10 is a concave-convex lens, which is a meniscus lens and is curved toward the object side; the second lens 20 is a biconcave lens; the third lens 30 is a plane-convex lens; the fourth lens 40 is a biconcave lens; the fifth lens 50 is a biconvex lens; and the sixth lens 60 is a biconvex lens. The above lens structure is beneficial to expanding field of view of the projection lens and realizing the effect of a large field of view. Also, the first lens 10, the first glued lens, the second glued lens, and the sixth lens 60 constitute a compact structure, which facilitates small-size modularization of the projection lens.

In one embodiment of the present disclosure, the first lens 10 is an aspheric lens.

In the present embodiment, by setting the surfaces of both sides of the first lens 10 as aspherical surfaces, the curvature through the center position and the curvature through the edge position are different, and the imaging result near the optical axis position and the imaging result away from the optical axis position may be adjusted so as to reduce the difference between the imaging near the optical axis position and the imaging away from the optical axis position and thus to reduce the aberration, so as to make the imaging clearer and to realize the effect of correcting aberration, which facilitates miniaturization of the projection lens. Likewise, by setting the surfaces of both sides of the sixth lens 60 as aspherical surfaces, it is possible to effectively eliminate spherical aberration, coma and astigmatism generated during optical imaging and realize the effect of correcting aberration. In the technical solution of the present disclosure, only two aspherical lenses are used in the entire projection lens, and compared with other projection lenses adopting three or even more aspherical lenses, the projection lens of the present embodiment achieves the purpose of reducing the production costs by reducing the number of aspherical lenses, and at the same time is able to ensure the imaging quality with high definition and low distortion.

In one embodiment of the present disclosure, the first lens 10 is made of optical plastic material.

In the present embodiment, the display unit 81 generates heat in the working process, such that the plastic lens in the projection lens is susceptible to deformation under the influence of high temperature, which is prone to shortening its service life and also degrades the imaging quality of the projection lens. Since the first lens 10 is furthest away from the display unit 81 in the projection lens and is least affected by high temperature, the first lens 10 may be set to be made of optical plastic, and compared with optical glass, optical plastic has the advantages of strong plasticity, light weight, and low processing cost.

In one embodiment of the present disclosure, the second lens 20, the third lens 30, the fourth lens 40, the fifth lens 50, and the sixth lens 60 are all made of optical glass.

Since glass is much lower than plastic at the same temperature in terms of distortion rate due to heat, and has good stability, the second lens 20, the third lens 30, the fourth lens 40, the fifth lens 50, and the sixth lens 60 near the display unit 81 may be set as glass to minimize the influence of high temperature on the projection lens. Further, in order to reduce the manufacturing cost, the sixth lens 60 may select a common molding glass with a low price.

In one embodiment of the present disclosure, please refer to FIGS. 1-2, the projection lens further comprises: a stop 70 provided between the first glued lens and the second glued lens.

In the present embodiment, the stop 70 is specifically an aperture stop 70 for limiting the diameter of the passing projection light, regulating the luminous flux emitted from the optical system, and at the same time reducing the interference of the spray light generated by the reflection through the other lenses, so as to make the imaging of the projection light clearer. Typically, the stop 70 has an aperture diameter of a fixed value; of course, in order to flexibly adjust the imaging clarity such that the projection lens is better able to switch between high and low resolutions, the stop 70 may also be set in such a way that the size of the aperture thereof may be adjusted.

As an alternative embodiment, the first lens 10 has a focal length of f₁, the first glued lens has a focal length of f_{2/3}, the second glued lens has a focal length of f_{4/5}, and the sixth lens 60 has a focal length of f₆, wherein, −15.5<f₁<−9.5, 15.5<f_{2/3}<22.5, −80.5<f_{4/5}<−52.5, 9.2<f₆<16.5. With the above structure, the projection lens of the present disclosure may be further optimized.

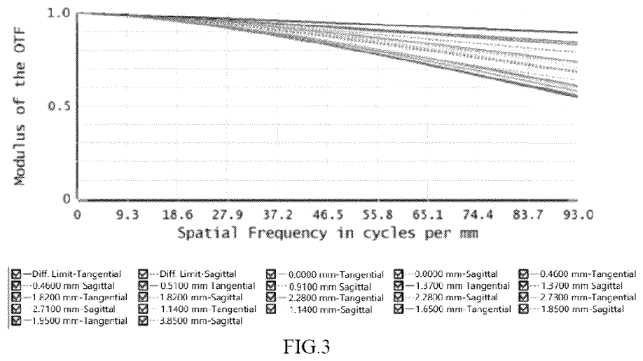

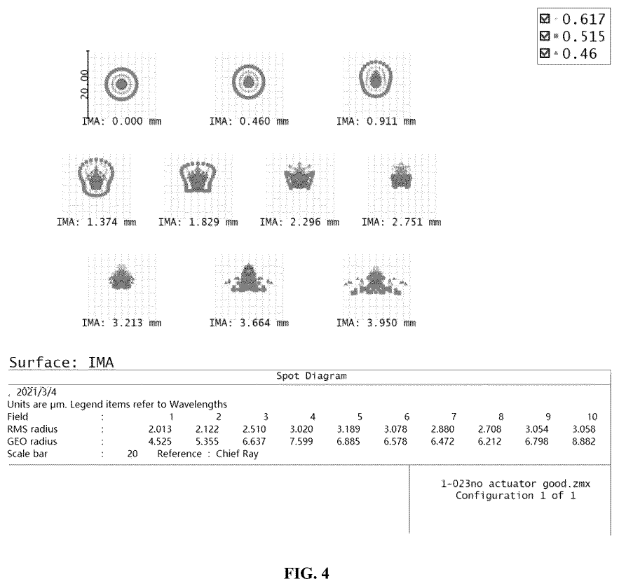

To further optimize the performance of the projection lens, please refer to FIG. 3, the radius of curvature and thickness of the surface of each lens, as well as the refractive index and Abbe number of each lens, are illustrated in the present disclosure. Here, a thickness recorded between two adjacent serial numbers indicates a distance between two adjacent lenses.

TABLE 1

| | radius of | thickness/ | refractive | Abbe |
|---|---|---|---|---|
| No. | curvature/mm | mm | index | number |
| first lens 10 | 50.9300 | 5.3000 | 1.5300 | 55.8661 |
| | 6.4000 | 2.7000 | | |
| first glued lens | −24.7152 | 2.0000 | 1.4700 | 66.8000 |
| (second lens 20, | 10.0000 | 4.6000 | 2.0000 | 25.4000 |
| third lens 30) | −78.0000 | 4.6000 | | |
| stop 70 | Infinity | 0.5000 | | |
| second glued lens | −11.4700 | 4.6000 | 1.7600 | 26.6000 |
| (fourth lens 40, fifth | 10.4000 | 5.0000 | 1.6200 | 63.8000 |
| lens 50) | −11.4500 | 1.5070 | | |
| sixth lens 60 | 11.1300 | 5.6610 | 1.4971 | 81.5947 |
| | −10.3800 | 2.9500 | | |
| prism 82 | Infinity | 10.5000 | 1.7130 | 53.8681 |
| | Infinity | 0.6000 | | |
| transparent | Infinity | 1.1000 | 1.5168 | 64.1673 |
| protective layer 83 | | | | |
| | | 0.3030 | | |
| display unit 81 | Infinity | | | |

In the present embodiment, the projection lens has a throw ratio of 1.2, which specifically refers to the ratio of the projection distance to the width of the projection picture. The diaphragm ratio of the projection lens is large diaphragm F no 1.7, which greatly meets the demands on brightness of the projection lens. Specifically, the diaphragm ratio refers to the ratio of the focal length to the diameter of the diaphragm: the smaller the diaphragm ratio is, the larger the relative aperture of the projection lens is and the larger the luminous flux; the larger the diaphragm ratio is, the smaller the relative aperture of the projection lens is and the smaller the luminous flux. The projection lens has an image telecentric light path within 1° and has a large angle of field of view (the angle of field of view is also known as field of view in optical engineering, its size determines the field of view of the optical instrument, and the angle of field of view may be expressed by FOV), which satisfies: 50°<FOV<70°. The projection lens works at a resolution of 960×540.

Based on the parameter data in Table 1, please refer to FIG. 3, it shows graphs of the chip surface Modulation Transfer Function for each field of view of the projection lens, that is, graphs of MTF, which refer to the relationship between the modulation index and the number of line-pairs per millimeter in the image, and is used to evaluate the ability to restore the details of the scene. In the case where the projection distance of the projection device is 1329 mm and the projection screen is 50 inches, with the projection angle being the frequency coordinate between the field-of-view samples and the vertical coordinate being the MTF value of the transfer function, it can be seen from FIG. 3 that the MTF >0.51@all field.

Based on the parameter data in Table 1, please refer to FIG. 4 which shows a light spot diagram; wherein, the light spot diagram is a dispersion graphic spread out over a certain area, which is formed since the points of intersection of many lights with the image plane are no longer concentrated at the same point due to aberration after many lights emitted by a point pass through the optical component, for evaluating the imaging quality of the projection optical system. The smaller the value of root mean square radius and geometric radius, the better the imaging quality. As can be seen from FIG. 4, the root mean square radius in the light spot diagram is up to 3.2 um in all fields of view, which is less than 5.4 um in pixels.

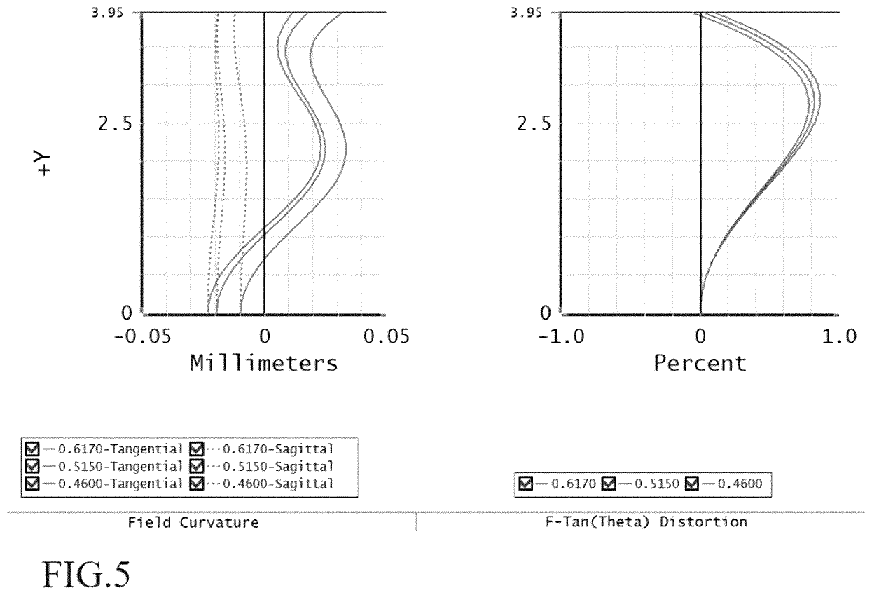

Based on the parameter data in Table 1, please refer to FIG. 5, FIG. 5 shows a field curvature and a distortion image of the projection lens, wherein, the field curvature refers to the curvature of field, and is mainly used to indicate the degree to which the intersection of the entire beam in the optical component does not coincide with the ideal image point. The distortion refers to the aberration of different parts of the object with different magnifications when the object is imaged through the optical component, and the distortion will cause the similarity of the object image to deteriorate but does not degrade the definition of the image. As can be seen from FIG. 5, the distortion is less than 0.8%, which meets the target, i.e., less than 1%.

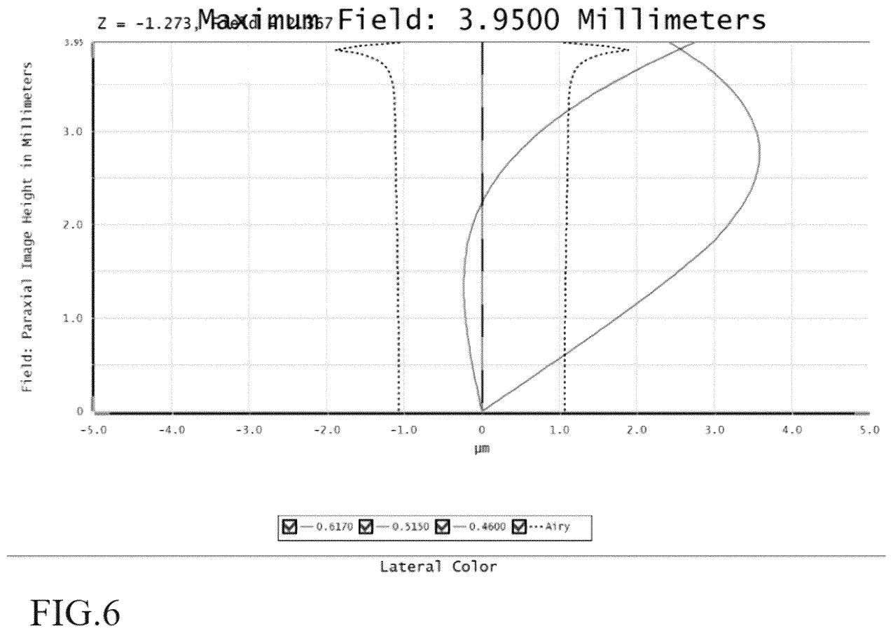

Based on the parameter data in Table 1, please refer to FIG. 6, FIG. 6 shows a chromatic aberration diagram of the projection lens, wherein, the vertical chromatic aberration, also known as multiplicity chromatic aberration, mainly refers to the difference between the focal position of hydrogen blue light and hydrogen red light in the image plane caused by the fact that a single main light of a complex color in the image side becomes multiple lights when emitted from the object side due to the existence of chromatic dispersion in the refraction system.

The present disclosure also proposes a projection device, please refer to FIG. 1 and FIG. 2, the projection device comprises a projection lens and a display unit 81, and the specific structure of the projection lens refers to the above embodiments. Since the present projection device adopts all of the technical solutions of all of the above-described embodiments, it has at least all of the beneficial effects brought about by the technical solutions of the above-described embodiments, which will not be repeated herein. Here, the display unit 81 is provided on a side of the sixth lens 60 facing away from the second glued lens.

In the present embodiment, the display unit 81 may be equipped with a Digital Micromirror Device (DMD) chip, and its specific size is 0.23 inches. DMD is composed of many digital micro-reflectors arranged in a matrix, each of which is capable of deflecting and locking in both positive and negative directions to project light in a given direction and oscillate at a frequency of tens of thousands of hertz so that the light beam from the illumination source enters the projection lens through the flip reflection of the micro-reflector and is imaged on the screen. DMD has the advantages of high resolution and no need for signal digital-to-analog conversion. Of course, the display unit 81 can also be equipped with a Liquid Crystal On Silicon (LCOS) chip or other display elements that can be used to emit light.

In one embodiment of the present disclosure, please refer to FIGS. 1-2, the projection device further comprises: a right-angle prism 82 provided between the sixth lens 60 and the display unit 81.

In the present embodiment, the prism 82 is specifically a right-angle prism 82 whose right-angle side has a length of 10.5 mm. The prism 82 may combine the three-color image of the light pulse signal from the display unit 81 into a single image and transmits the corresponding projection light signal to the projection lens for subsequent image display.

In one embodiment of the present disclosure, please refer to FIGS. 1-2, the projection device further comprises: a transparent protective layer 83 provided on a side of the display unit 81 facing away from the sixth lens 60.

In the present embodiment, the transparent protective layer 83 is specifically a coverslip with a thickness of 1.1 mm. The coverslip is placed on the light-emergent surface of the display unit 81, which can effectively protect the display unit 81 while ensuring good light transmittance, thereby preventing external dust from entering into the display unit 81.

The above are only the preferred embodiments of the present disclosure, and are not intended to limit the patent scope of the present disclosure. Any equivalent structural transformations made by utilizing the specification of the present disclosure and the accompanying drawings under the concept of the present disclosure or directly/indirectly applying them in other related technical fields shall be included in the scope of patent protection of the present disclosure.

1. A projection lens arranged along a single optical axis from an object side to an image side, comprising:
a first lens having a negative focal power;
a first glued lens comprising a second lens and a third lens, wherein the second lens is located between the first lens and the third lens, the second lens and the third lens are glued to each other on opposing surfaces thereof, and the first glued lens has a positive focal power;
a second glued lens comprising a fourth lens and a fifth lens, wherein the fourth lens is located between the third lens and the fifth lens, the fourth lens and the fifth lens are glued to each other on opposing surfaces thereof, and the second glued lens has a negative focal power; and
a sixth lens having a positive focal power.

2. The projection lens of claim 1, wherein the first lens has a convex surface on a side facing the object side, and a concave surface on a side facing the image side;
the second lens has a concave surface on a side facing the object side, and a concave surface on a side facing the image side;
the third lens has a convex surface on a side facing the object side, and a convex surface on a side facing the image side;
the fourth lens has a concave surface on a side facing the object side, and a concave surface on a side facing the image side;
the fifth lens has a convex surface on a side facing the object side, and a convex surface on a side facing the image side;
the sixth lens has a convex surface on a side facing the object side, and a convex surface on a side facing the image side.

3. The projection lens of claim 1, wherein the first lens has a focal length of f₁, the first glued lens has a focal length of f_{2/3}, the second glued lens has a focal length of f_{4/5}, and the sixth lens has a focal length of f₆,
wherein, −15.5<f₁<−9.5, 15.5<f_{2/3}<22.5, −80.5<f_{4/5}<−52.5, 9.2<f₆<16.5.

4. The projection lens of claim 1, wherein the projection lens has a focal length of f, wherein 5.2<f<8.5.

5. The projection lens of claim 1, wherein the first lens is an aspheric lens; and/or
the sixth lens is an aspheric lens.

6. The projection lens of claim 1, wherein the first lens is made of optical plastic material; and/or
the second lens, the third lens, the fourth lens, the fifth lens, and the sixth lens are all made of optical glass.

7. The projection lens of claim 1, further comprising:
a stop provided between the first glued lens and the second glued lens.

8. A projection device, comprising:
the projection lens of claim 1; and
a display unit, provided on a side of the sixth lens facing away from the second glued lens.

9. The projection device of claim 8, further comprising:
a right-angle prism provided between the sixth lens and the display unit.

10. The projection device of claim 8, further comprising:
a transparent protective layer provided on a side of the display unit facing away from the sixth lens.

11. The projection device of claim 9, further comprising:
a transparent protective layer provided on a side of the display unit facing away from the sixth lens.
